(19) United States
(12) Patent Application Publication
(10) Pub. No.: US 2024/0014530 A1
(43) Pub. Date: Jan. 11, 2024

(54) SAFETY IMPROVED PRISMATIC SECONDARY BATTERY

(71) Applicant: LG ENERGY SOLUTION, LTD., Seoul (KR)

(72) Inventors: Cheon Hee BOK, Daejeon (KR); Joo Hwan SUNG, Daejeon (KR)

(21) Appl. No.: 18/220,198

(22) Filed: Jul. 10, 2023

(30) Foreign Application Priority Data
Jul. 7, 2022 (KR) 10-2022-0083631

(51) Int. Cl. H01M 50/578; H01M 50/15; H01M 50/55; H01M 50/581; H01M 50/103; H01M 50/583

(52) U.S. Cl. CPC H01M 50/578; H01M 50/15; H01M 50/55; H01M 50/581; H01M 50/103; H01M 50/583

(57) ABSTRACT

A cap plate is hermetically coupled to an open side of a prismatic case and provided with an electrode terminal. The cap plate includes a first part coupled and electrically connected to the electrode terminal. The first part includes a pressure deformation portion configured to deform toward the electrode terminal upon receiving a pressure. The cap plate includes a second part includes a first portion coupled to the pressure deformation portion of the first part, and a second portion coupled to an electrode lead of an electrode assembly.

### CROSS-REFERENCE TO RELATED APPLICATION

This application claims the benefit of Korean Application No. 10-2022-0083631, filed on Jul. 7, 2022, the contents of which are all hereby incorporated by reference herein in its entirety.

### TECHNICAL FIELD

The present disclosure relates to a safety-improved prismatic secondary battery that stops applying current when the prismatic secondary battery is in an abnormal state of overcharging or external short circuit, thereby preventing various accidents such as thermal runaway, cell explosion, heat propagation, etc.

### BACKGROUND

Unlike primary batteries, secondary batteries can be recharged, and they have been heavily researched and developed in recent years due to their potential for miniaturization and large capacity. The demand for secondary batteries as an energy source is increasing rapidly due to the technological development and increasing demand for mobile devices, and due to electric vehicles and energy storage systems, which are emerging in response to the need for environmental protection.

Secondary batteries are categorized into coin-type cells, cylindrical cells, prismatic cells, and pouch-type cells based on the shape of the battery case. In a secondary battery, an electrode assembly mounted inside the battery case is a chargeable/dischargeable power generator consisting of a laminated structure of electrodes and separators.

Since secondary batteries are required to be used continuously for a long period of time, it is necessary to effectively control the heat generated during the charging and discharging process. In addition, if the secondary battery is overcharged or an external short circuit occurs and an overcurrent is applied, the increase in current causes the temperature to rise, and the increase in temperature causes the current to increase again, resulting in a feedback chain reaction that eventually leads to the catastrophic condition of thermal runaway, and the severe thermal runaway condition may cause a fire or explosion of the secondary battery.

In addition, if the secondary batteries are grouped together in the form of modules or packs, the thermal propagation phenomenon occurs, in which the thermal runaway of one secondary battery continuously overheats other secondary batteries in the vicinity. Furthermore, there is a high risk of fire due to flammable gases emitted from overheated secondary batteries and due to ignition sources such as heated electrodes.

Therefore, it is necessary to prepare safety measures to prevent various accidents such as thermal runaway, cell explosion, and even heat propagation by automatically stopping the current application when the secondary battery is in an abnormal state of overcharging or external short circuit.

### SUMMARY

The present disclosure aims to provide a safety improved prismatic secondary battery that automatically stops applying current when the secondary battery is in an abnormal state of overcharging or external short circuit, thereby preventing various accidents such as thermal runaway, cell explosion, and heat propagation.

However, the technical problems that the present disclosure seeks to address are not limited to those described above, and other problems not mentioned will be apparent to those of ordinary skill in the art from the following description of the disclosure.

The present disclosure relates to a cap plate hermetically coupled to an open side of a prismatic case and coupled to an electrode terminal, wherein, in one example, the cap plate includes: a first part coupled and electrically connected to the electrode terminal, and the first part including a pressure deformation portion configured to deform toward the electrode terminal upon receiving a pressure; and a second part comprising a first portion coupled to the pressure deformation portion of the first part, and a second portion coupled to an electrode lead of an electrode assembly.

The second part is configured to separate from the first part when the pressure deformation portion of the first part is deformed toward the electrode terminal upon receiving the pressure.

In addition, the first part is configured to deform to a convex shape with respect to the electrode terminal based on the pressure when the pressure deformation portion is in a concave with respect to the electrode terminal, and in one exemplary embodiment, the pressure deformation portion may have a truncated square pyramid shape.

The first portion of the second part may be provided with a junction coupled to the pressure deformation portion of the first part, and the first portion includes a plurality of legs connecting the junction with the second portion of the second part. The second portion includes a main body of the second part.

Here, the main body of the second part is joined to the electrode lead of the electrode assembly, and the plurality of legs of the second part is configured to separate from the junction or the main body upon deformation of the pressure deformation portion.

Meanwhile, in another exemplary embodiment of the present disclosure, a cap plate hermetically coupled to an open side of a prismatic case and provided with an electrode terminal includes: a first part coupled and electrically connected to the electrode terminal, and the first part comprising a temperature deformation portion configured to deform toward the electrode terminal based on an increase in temperature; and a second part having a first portion coupled to the temperature deformation portion of the first part, and having a second portion coupled to an electrode lead of an electrode assembly.

The second part is configured to separate from the first part when the temperature deformation portion of the first part is deformed toward the electrode terminal by the increase in temperature.

In addition, the first part deforms when the temperature deformation portion bends toward the electrode terminal based on the increase in temperature.

The a first portion of the second part may include a junction coupled to the temperature deformation portion of the first part, and the first portion includes a plurality of legs connecting the junction with the second portion of the second part. The second portion includes a main body of the second part.

In such an exemplary embodiment, the main body of the second part is joined to the electrode lead of the electrode assembly, and the plurality of legs of the second part is ruptured from the junction or the main body upon deformation of the temperature deformation portion.

In addition, the present disclosure provides a prismatic secondary battery including: a case comprising an open side; an electrode assembly received within the case through the open side of the case; and a cap plate coupled to the case to seal the open side of the case and having a pressure deformation portion, wherein the pressure deformation portion of the first part deforms to a convex shape with respect to the electrode terminal in response to an increase in pressure inside the case.

In addition, the present disclosure provides a prismatic secondary battery including: a case comprising an open side; an electrode assembly received within the case through the open side of the case; and a cap plate coupled to the case to seal the open side of the case and having a pressure deformation portion, wherein the temperature deformation portion of the first part deforms by bending toward the electrode terminal in response to a temperature increase corresponding to an amount of current flowing in the electrode terminal.

In the prismatic secondary battery of the present disclosure having the above configuration, the first part joined to the electrode terminal deforms in response to an increase in pressure or temperature, and the second part joined to the first part ruptures in an emergency state in conjunction with the deformation of the first part, forcing the electrical connection with the electrode assembly to be disconnected.

Therefore, the present disclosure can prevent various accidents such as thermal runaway, cell explosion, heat propagation, etc. by providing the electrode terminal with a safety means that automatically short-circuits in response to an abnormal increase in pressure or temperature.

However, the technical effects of the present disclosure are not limited to those described above, and other effects not mentioned will be apparent to one of ordinary skill in the art from the following description of the disclosure.

### BRIEF DESCRIPTION OF THE DRAWINGS

The accompanying drawings illustrate exemplary embodiments of the present disclosure and, together with the following detailed description, serve to provide further understanding of the technical spirit of the present disclosure. Therefore, the present disclosure is not to be construed as being limited to the drawings.

FIG. 1 is a drawing illustrating a cap plate according to an exemplary embodiment of the present disclosure.

FIG. 2 is a drawing of an example of a prismatic secondary battery having the cap plate of FIG. 1.

FIG. 3 is a drawing illustrating a normal coupled state of the cap plate and electrode leads of FIG. 1.

FIG. 4 is a drawing illustrating a state in which a cap plate and electrode leads are separated from each other by increased pressure inside a case.

FIG. 5 is a drawing illustrating a cap plate according to another exemplary embodiment of the present disclosure.

FIG. 6 is a drawing illustrating a normal coupled state of the cap plate and electrode leads of FIG. 5.

FIG. 7 is a drawing illustrating a state in which a cap plate and electrode leads are separated from each other by an increase in the amount of current flowing through the electrode terminal.

### DETAILED DESCRIPTION

While the present disclosure may be variously changed and have various embodiments, specific embodiments will be described in detail below.

However, it is to be understood that the present disclosure is not limited to the specific embodiments described herein but includes all modifications, equivalents, and substitutions included in the spirit and the scope of the present disclosure.

In this application, it should be understood that terms such as “include” or “have” are intended to indicate the presence of a feature, number, step, operation, component, part, or a combination thereof described on the specification, and they do not preclude the possibility of the presence or addition of one or more other features or numbers, steps, operations, components, parts or combinations thereof.

In addition, in this application, when a portion such as a layer, a film, an area, a plate, and the like are referred to as being “on” another portion, this includes not only the case where the portion is “directly on” another portion but also the case where still another portion is interposed therebetween. On the other hand, when a portion such as a layer, a film, an area, a plate, and the like are referred to as being “under” another portion, this includes not only the case where the portion is “directly under” another portion but also the case where still another portion is interposed therebetween. In addition, to be disposed “on” in the present application may include the case of being disposed at the bottom as well as the top.

The present disclosure relates to a cap plate hermetically coupled to an open side of a prismatic case and having electrode terminals, wherein, in one example, the cap plate includes a first part coupled and electrically connected to the electrode terminal, and including a pressure deformation portion deformed toward the electrode terminal by an external pressure; and a second part having a part joined to the pressure deformation portion of the first part, and having another part joined to an electrode lead of an electrode assembly.

Here, the second part has a part to which the electrode lead is joined that becomes separated from the first part when the pressure deformation portion of the first part is deformed toward the electrode terminal by an external pressure.

As such, the cap plate of the present disclosure has a structure in which a part of the second part to which the electrode leads are joined is separated from the first part in response to an increase in pressure. Therefore, when the cap plate of the present disclosure is hermetically joined to the case of a prismatic secondary battery, if a situation occurs in which the electrode assembly overheats and the temperature and pressure inside the case rise, the pressure deformation portion of the first part is deformed toward the electrode terminal in response to the high pressure formed inside the case, and a part of the second part to which the electrode leads are joined is separated from the first part, thereby short-circuiting the electrical connection of the electrode assembly.

As such, the cap plate of the present disclosure is equipped with a safety means to forcibly disconnect the electrical connection of the electrode assembly in an emergency situation such as a thermal runaway generated in the secondary battery so that no further current flows, thereby greatly improving the safety of the prismatic secondary battery.

Hereinafter, specific embodiments of the prismatic secondary battery of the present disclosure will be described in detail with reference to the accompanying drawings. For reference, the directions of front, back, up, down, left and right designating relative positions used in the following description are for the purpose of understanding the disclosure, and refer to the directions shown in the drawings unless otherwise specified.

### First Embodiment

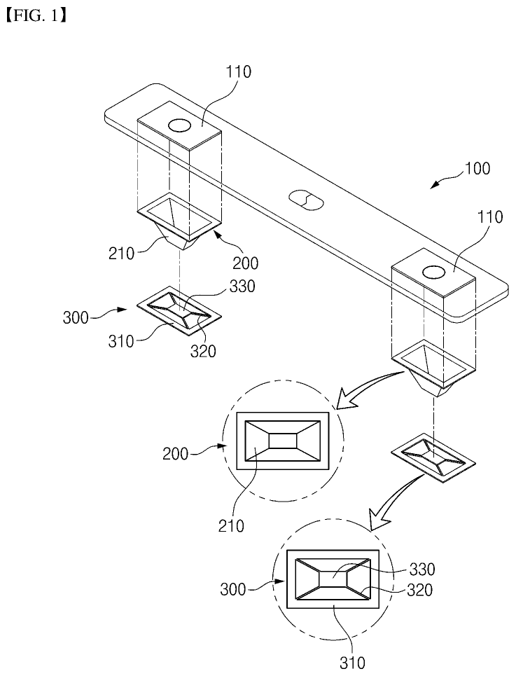

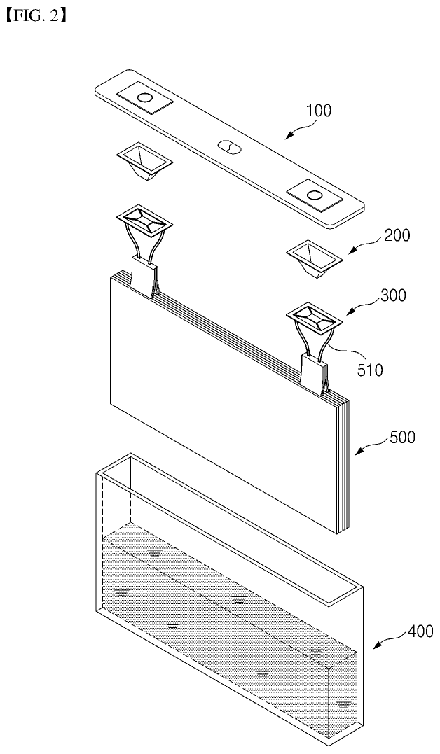

FIG. 1 is a diagram illustrating a cap plate 100 according to an exemplary embodiment of the present disclosure. The cap plate 100 is hermetically coupled to an open side of the prismatic case 400 to form one side of the prismatic secondary battery 10. FIG. 2 is a diagram of an example of a prismatic secondary battery 10 having the cap plate 100 of FIG. 1. In the first embodiment shown, the cap plate 100 forms a top surface of the prismatic secondary battery 10.

The cap plate 100 is provided with an electrode terminal 110. The electrode terminal 110 is a terminal that interconnects the electrode assembly 500 housed inside the prismatic secondary battery 10 with an external electrical circuit, and charging and discharging of the prismatic secondary battery 10 is performed through the electrode terminal 110.

Here, the cap plate 100 of the present disclosure has safety means to forcibly disconnect the electrical connection between the electrode assembly 500 and the electrode terminal 110 in an emergency situation. In the first embodiment, the safety means of the cap plate 100 includes a first part 200 and a second part 300. The first part 200 and the second part 300 are mutually coupled, and the first part 200 deforms in response to an increase in pressure inside the case 400, for example, an increase in pressure when the electrode assembly 500 inside the sealed case 400 overheats, resulting in an increase in temperature and pressure, and the second part 300, in conjunction with this deformation of the first part 200, short-circuits the electrical connection between the electrode terminal 110 and the electrode assembly 500.

Specific embodiments of the first part 200 and the second part 300 will be described in detail with reference to FIGS. 1 and 2.

The first part 200 is a conductive part that is electrically connected while mechanically coupled to the electrode terminal 110 of the cap plate 100. In addition, the first part 200 has a pressure deformation portion 210 that is deformed toward the electrode terminal 110 by an external pressure.

For example, the pressure deformation portion 210 may be reversely deformed from its normal state of being concave with respect to the electrode terminal 110 to a convex shape when a certain level of external pressure is applied. In other words, the pressure deformation portion 210 is closer to the electrode terminal 110 than it would normally be if it were deformed with respect to the electrode terminal 110 at a pressure above a threshold.

The shape of such pressure deformation portion 210 may be in the form of a truncated square pyramid, as shown in FIG. 1. In normal use, the pressure deformation portion 210 has the narrow base of the truncated square pyramid facing away from the electrode terminal 110. In other words, in normal use, the pressure deformation portion 210 is concave with respect to the electrode terminal 110.

Such a pressure deformation portion 210 may be reversely deformed from a concave shape to a convex shape by the external pressure pushing the narrow base of the truncated square pyramid toward the electrode terminal 110. Considering this reverse deformation of the pressure deformation portion 210, it can be said that the shape of a pyramid, such as a truncated square pyramid, is more preferable as the shape of the pressure deformation portion 210 than the shape of a sphere, which has the property of distributing the external pressure evenly and being resistant to deformation.

The second part 300 is partially joined to the pressure deformation portion 210 of the first part 200, and partially joined to the electrode lead 510 of the electrode assembly 500. The second part 300 is also made of a conductive material, so that the electrode terminal 110 and the electrode assembly 500 are electrically connected via the first part 200 and the second part 300.

Here, the second part 300 has a structure such that when the pressure deformation portion 210 of the first part 200 is deformed toward the electrode terminal 110 by an external pressure, the part to which the electrode lead 510 is joined is physically separated from the first part 200. That is, a part of the second part 300 joined to the first part 200 and the pressure deformation portion 210 moves toward the electrode terminal 110 as a unit, and in the process, the other part of the second part 300 joined to the electrode lead 510 of the electrode assembly 500 falls off, thereby physically and electrically separating the electrode terminal 110 and the electrode assembly 500 from each other.

To facilitate such separation of the second part 300, the second part 300 may include a junction 330 joining the pressure deformation portion 210 of the first part 200, and a plurality of legs 320 connecting the junction 330 to the main body 310 of the second part 300. Referring to FIG. 1, the second part 300 has a main body 310 in the form of a rectangular frame forming an outer part, legs 320 extend one by one from four inner corners of the main body 310 toward a center, and junctions 330 connected to the four legs 320 are disposed in the center region.

The junction 330 located at the center of the second part 300 is joined to the center of the pressure deformation portion 210, which is shaped like a truncated square pyramid of the first part 200. Since the part with the greatest displacement when the pressure deformation portion 210 is deformed is the narrow base of the truncated square pyramid, it is preferred that the junction 330 of the second part 300 be joined to the center of the pressure deformation portion 210 of the first part 200 for smooth separation of the second part 300. The joining of the junction 330 and the pressure deformation portion 210 may be accomplished, for example, by laser welding.

In addition, the electrode lead 510 of the electrode assembly 500 are joined to the main body 310 of the second part 300, and the legs 320 of the second part 300 rupture from the junction 330 or main body 310 by a deformation of the pressure deformation portion 210. In other words, because the main body 310 of the second part 300 is fixed relative to the electrode assembly 500, the legs 320 of the second part 300 are deformed and ruptured as the junction 330 of the second part 300 moves toward the electrode terminal 110 with the pressure deformation portion 210 of the first part 200.

The legs 320 of the second part 300 are subject to rupture at a part where stress is concentrated, and to ensure a complete rupture, the legs 320 may be notched at one point. In particular, since stresses are concentrated at the corners of the junction 330 and the main body 310 where the legs 320 are connected, it is effective to form notches at these corners. A ruptured leg 320 will remain on either side of the junction 330 or the main body 310. FIG. 2 is a diagram illustrating an example of a prismatic secondary battery 10 having the cap plate 100 of FIG. 1. The prismatic secondary battery 10 of FIG. 2 includes a case 400 having at least one side forming an open side, an electrode assembly 500 received within the case 400 through the open side of the case 400, and a cap plate 100 coupled to seal the open side of the case 400 and provided with the pressure deformation portion 210 described above.

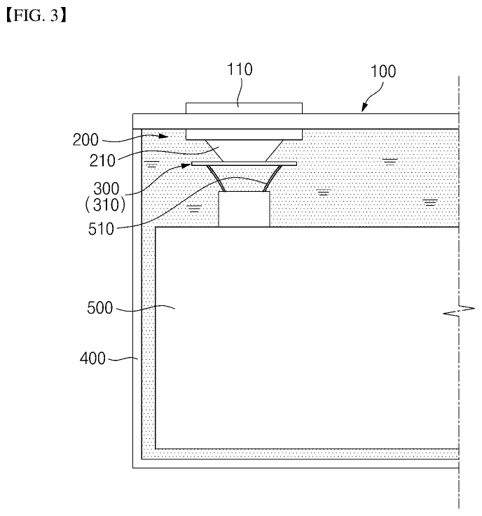

FIG. 3 is a diagram illustrating a normal coupled state of the cap plate 100 and electrode leads 510 of FIG. 1, wherein the pressure deformation portion 210 of the first part 200 joined to the electrode terminal 110 is concave relative to the electrode terminal 110. In addition, a main body 310 of the second part 300 is joined to an electrode lead 510 of the electrode assembly 500.

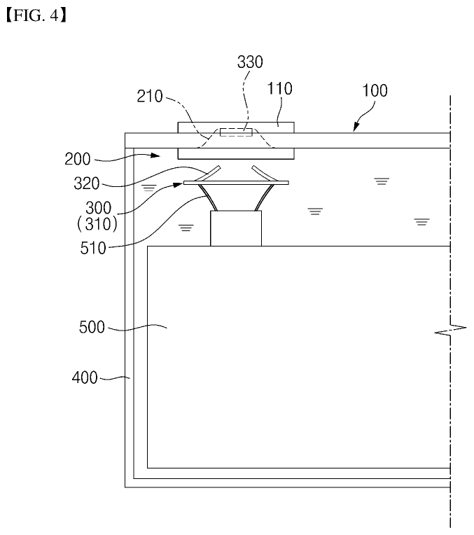

FIG. 4 is a diagram illustrating a state in which a cap plate 100 and electrode leads 510 are separated from each other by increased pressure inside a case 400. When the electrode assembly 500 overheats, increasing the temperature and pressure inside the case 400, the pressure deformation portion 210 of the first part 200 deforms into a convex shape relative to the electrode terminal 110 in response to the increased pressure inside the case 400.

As the pressure deformation portion 210 of the first part 200 is reversely deformed, the junction 330 of the second part 300 that is joined to the pressure deformation portion 210 is also moved along with it toward the electrode terminal 110, and in the process, the legs 320 of the second part 300 rupture, causing the junction 330 of the second part 300 and the main body 310 to separate from each other. Since the electrode lead 510 of the electrode assembly 500 has the main body 310 joined to the second part 300, the electrical connection between the electrode assembly 500 and the electrode terminals 110 is eventually disconnected, thereby stopping the charge and discharge of the electrode assembly 500.

Here, the safety means, the first part 200 and the second part 300, may be provided on at least one of the two electrode terminals 110 of a positive electrode and a negative electrode. If either of the positive or negative electrode electrical connections between the electrode terminals 110 and the electrode assembly 500 is disconnected, the charge and discharge to the electrode assembly 500 is blocked.

### Second Embodiment

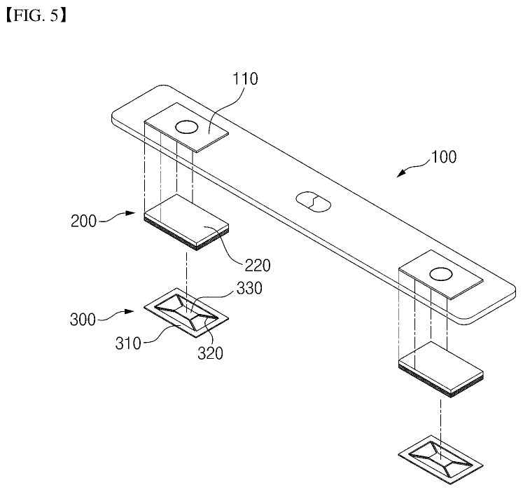

FIG. 5 is a drawing illustrating a cap plate 100 according to a second embodiment of the present disclosure. The cap plate 100 of the second embodiment differs from the first embodiment in the first part 200, while the configuration of the second part 300 remains the same, and the function of the second part 300 as a safety means for separating the main body 310 of the second part 300 from the first part 200 with the electrode leads 510 joined in the event of an emergency is also the same. The following description will focus on the characteristic configuration of the second embodiment.

In the second embodiment, the first part 200 has a temperature deformation portion 220 that deforms toward the electrode terminal 110 due to a temperature increase. In other words, the first part 200 in the first embodiment has a pressure deformation portion 210 that responds to a pressure increase, while the first part 200 in the second embodiment has a temperature deformation portion 220 that responds to a temperature increase.

In the second part 300, the main body 310 of the second part 300 to which the electrode leads 510 are joined is separated from the first part 200 when the temperature deformation portion 220 of the first part 200 is deformed in a form that bends toward the electrode terminal 110 due to an increase in temperature. The temperature deformation portion 220 of the first part 200 responds to the rising temperature in response to the amount of current flowing through the electrode terminal 110. That is, when the amount of current flowing through the electrode terminal 110 exceeds a threshold and the temperature rises excessively, the temperature deformation portion 220 bends toward the electrode terminal 110.

The temperature deformation portion 220 of the first part 200 may form a bimetallic structure in which two metals with different thermal expansion rates are joined. If the metal with the smaller coefficient of thermal expansion is disposed closer to the electrode terminal 110, when the temperature of the first part 200 is increased, the metal with the larger coefficient of thermal expansion on the far side is stretched more, causing the temperature deformation portion 220 to bend toward the electrode terminal 110.

The second part 300 has a junction 330 that joins the temperature deformation portion 220 of the first part 200, and a plurality of legs 320 that connect the junction 330 to the main body 310 of the second part 300. Then, the electrode lead 510 of the electrode assembly 500 is joined to the main body 310 of the second part 300, and the legs 320 of the second part 300 are ruptured from the junction 330 or the main body 310 by the deformation of the temperature deformation portion 220 of the first part 200.

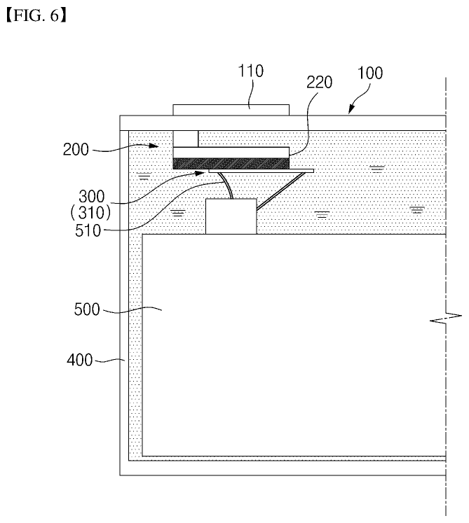

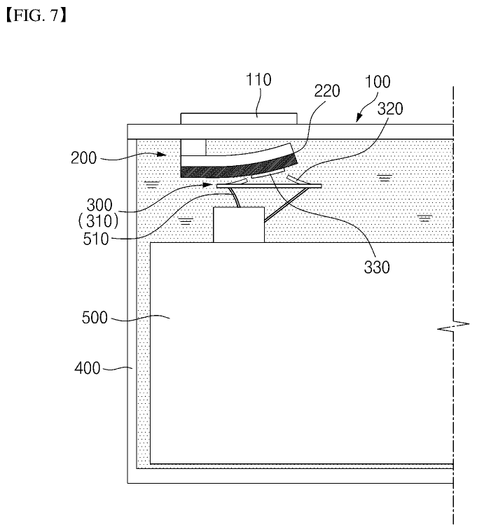

FIG. 6 is a diagram showing a normal coupled state of the cap plate 100 and electrode leads 510 of FIG. 5, and FIG. 7 is a diagram showing a state in which a cap plate 100 and electrode leads 510 are separated from each other by an increase in the amount of current flowing through the electrode terminal 110.

As shown in FIG. 6, in normal use, the first part 200 and the second part 300 are joined together, and the main body 310 of the second part 300 is joined to the electrode lead 510 of the electrode assembly 500. Thus, the electrode terminal 110 and the electrode assembly 500 are electrically connected, and charging and discharging through the electrode terminal 110 is possible.

FIG. 7 shows a case in which an overcurrent flows to the electrode terminal 110, causing an excessive charge and discharge to the electrode assembly 500, and the temperature deformation portion 220 of the first part 200 heated by the overcurrent bends toward the electrode terminal 110. Accordingly, the junction 330 of the second part 300 joined to the temperature deformation portion 220 also moves toward the electrode terminal 110 together, and in this process, the legs 320 of the second part 300 rupture and the junction 330 and the main body 310 of the second part 300 become mutually separated. Eventually, the interaction of the first part 200 and the second part 300 breaks the electrical connection between the electrode assembly 500 and the electrode terminal 110, thereby stopping the charge and discharge to the electrode assembly 500, thereby preventing the prismatic secondary battery 10 from reaching a catastrophic failure.

For reference, it should be noted that the cap plate 100 according to the second embodiment can also be applied to the prismatic secondary battery 10 in the same manner as the example in FIG. 2, and will not be repeatedly described.

The present disclosure has been described in more detail above with reference to the drawings and embodiments. However, it is to be understood that the configurations shown in the drawings or embodiments described herein are only one embodiment of the disclosure and do not represent all of the technical ideas of the disclosure, and that there may be various equivalents and modifications that may replace them at the time of filing the present application.

### REFERENCE NUMERALS

10: PRISMATIC SECONDARY BATTERY
100: CAP PLATE
110: ELECTRODE TERMINAL
200: FIRST PART
210: PRESSURE DEFORMATION PORTION
220: TEMPERATURE DEFORMATION PORTION
300: SECOND PART
310: MAIN BODY
320: LEG
330: JUNCTION
400: CASE
500: ELECTRODE ASSEMBLY
510: ELECTRODE LEAD

1. A cap plate hermetically coupled to an open side of a prismatic case and provided with an electrode terminal, the cap plate comprising:
a first part coupled and electrically connected to the electrode terminal, the first part comprising a pressure deformation portion configured to deform toward the electrode terminal upon receiving a pressure; and
a second part comprising a first portion coupled to the pressure deformation portion of the first part, and a second portion coupled to an electrode lead of an electrode assembly.

2. The cap plate of claim 1, wherein the second part is configured to separate from the first part when the pressure deformation portion of the first part is deformed toward the electrode terminal upon receiving the pressure.

3. The cap plate of claim 2, wherein the first part is configured to deform to a convex shape with respect to the electrode terminal based on the pressure when the pressure deformation portion is in a concave shape with respect to the electrode terminal.

4. The cap plate of claim 3, wherein the pressure deformation portion has a truncated square pyramid shape.

5. The cap plate of claim 3, wherein the first portion of the second part comprises a junction coupled to the pressure deformation portion of the first part,
wherein the first portion comprises a plurality of legs connecting the junction with the second portion of the second part, and
wherein the second portion comprises a main body of the second part.

6. The cap plate of claim 5, wherein the main body of the second part is joined to the electrode lead of the electrode assembly, and
wherein the plurality of legs of the second part is configured to separate from the junction or the main body upon deformation of the pressure deformation portion.

7. A cap plate hermetically coupled to an open side of a prismatic case and provided with an electrode terminal, the cap plate comprising:
a first part coupled and electrically connected to the electrode terminal, the first part comprising a temperature deformation portion configured to deform toward the electrode terminal based on an increase in temperature; and
a second part comprising a first portion coupled to the temperature deformation portion of the first part, and comprising a second portion coupled to an electrode lead of an electrode assembly.

8. The cap plate of claim 7, wherein the second part is configured to separate from the first part when the temperature deformation portion of the first part is deformed toward the electrode terminal by the increase in temperature.

9. The cap plate of claim 8, wherein the first part deforms when the temperature deformation portion bends toward the electrode terminal based on the increase in temperature.

10. The cap plate of claim 9, wherein the first portion of the second part comprises a junction coupled to the temperature deformation portion of the first part, and
wherein the first portion comprises a plurality of legs connecting the junction with the second portion of the second part, and
wherein the second portion comprises a main body of the second part.

11. The cap plate of claim 10, wherein the main body of the second part is joined to the electrode lead of the electrode assembly, and
wherein the plurality of legs of the second part is configured to separate from the junction or the main body upon deformation of the temperature deformation portion.

12. A prismatic secondary battery comprising:
a case comprising an open side;
an electrode assembly received within the case through the open side of the case; and
the cap plate according to claim 1,
wherein the cap plate is coupled to the case to seal the open side of the case.

13. The prismatic secondary battery of claim 12, wherein the pressure deformation portion of the first part deforms to a convex shape with respect to the electrode terminal in response to an increase in pressure inside the case.

14. A prismatic secondary battery comprising:
a case comprising an open side;
an electrode assembly received within the case through the open side of the case; and
a cap plate according to claim 7,
wherein the cap plate is coupled to the case to seal the open side of the case.

15. The prismatic secondary battery of claim 14, wherein the temperature deformation portion of the first part deforms by bending toward the electrode terminal in response to a temperature increase corresponding to an amount of current flowing in the electrode terminal.
